(19) United States
(12) Patent Application Publication
(10) Pub. No.: US 2008/0014801 A1
(43) Pub. Date: Jan. 17, 2008

(54) WIRE GUIDE AND CONNECTOR ASSEMBLY USING SAME

(76) Inventors: Luc Milette, Montreal (CA); Michel Bohbot, Montreal (CA)

Correspondence Address: GOUDREAU GAGE DUBUC, 2000 MCGILL COLLEGE, SUITE 2200, MONTREAL, QC, H3A 3H3, CA

(21) Appl. No.: 11/776,259

(22) Filed: Jul. 11, 2007

Related U.S. Application Data
(62) Division of application No. 10/986,206, filed on Nov. 12, 2004, now Pat. No. 7,249,962.
(60) Provisional application No. 60/519,625, filed on Nov. 14, 2003.

(30) Foreign Application Priority Data
Nov. 14, 2003 (CA) 2,449,528

(51) Int. Cl. H01R 31/00

(52) U.S. Cl. 439/638

(57) ABSTRACT

A wire guide, method and connector assembly for interconnecting an end of a cable comprising at least two twisted pairs of conductors, each of the conductors enveloped in an insulating covering, with the bifurcated contacts of a connecting block. The assembly comprises an insulated housing, at least two pairs of non-contacting conductive terminals disposed in the housing, each of the terminals comprising a blade exposed along a front face of the housing and adapted to be inserted into one of the bifurcated contacts, and a piercing mechanism, and at least two guideways between the cable end and the pair of conductive terminals, one guideway for guiding each of the twisted pairs, wherein two of the guideways are arranged such that, at a point of intersection, the twisted pairs carried by each of cross substantially at right angles. Each of the conductors is terminated by one of the terminals, the piercing mechanism puncturing the insulated covering of a free end of the conductor thereby bringing the terminal into conductive contact with the conductor.

### CROSS REFERENCE OF RELATED APPLICATIONS

The present application is a divisional application of U.S. patent application Ser. No. 10/986,206, which in turn claims the benefit of a commonly assigned provisional application entitled “Connector Assembly”, which was filed on Nov. 14, 2003 and assigned Ser. No. 60/519,625. The entire contents of the foregoing applications are hereby incorporated by reference.

### FIELD OF THE INVENTION

The present invention relates to a wire guide and connector assembly using same. In particular the present invention relates to a wire guide for guiding the conductors of a cable terminated at a plurality of terminals.

### BACKGROUND OF THE INVENTION

A variety of prior art systems exist for terminating the ubiquitous twisted pair cables used in telecommunication systems with a connector suitable for insertion to a connector block comprised of a series of Insulation Displacement Connectors (IDCs). These prior art systems typically provide, within the connector housing, a means for retaining the cables within the housing, for example by means of collars or the like which, during assembly, encircle the cable thereby hindering its retraction from the connector housing. Additionally, to simplify the assembly of such connectors in the field, the connectors, which are typically of two part construction, typically comprise a series of bifurcated IDC connectors arranged in one side of the connector housing into which the ends of the twisted pairs of conductors can be inserted using a suitable tool. As is known in the art, such IDC connectors slice through the insulating covering of the individual conductors, thereby bringing the conductor into contact with the IDC connector. The IDC connectors are in turn connected to, or form part of, a terminal which is exposed along a front face of the connector, the terminals adapted for insertion into the connector block.

There are also disclosed prior art connectors which provide posts or the like around which the conductors can be arranged thereby improving to some degree the performance of the cable/connector as well as the strength of the assembled cable/connector.

However, the above discussed prior art devices typically untwist a relatively large amount of conductor from each twisted pair in order to align the conductor with and insert it into the provided IDC connector. Additionally, no effort is made in such prior art conductors to ensure that the point of contact between twisted pairs emerging from the exposed end of the cable, at least two of which must typically be crossed in order to be attached in the correct sequence with the IDC connectors, is minimised. Furthermore, the point of insertion of the individual conductors into the IDC connectors is typically arranged along a parallel line, which may give rise to unwanted cross-talk and the like thereby reducing performance of the connectors, especially at high frequencies.

As a result, the above discussed prior art devices are typically unsuitable for use in connectors which must meet the Category 6 performance standards.

### SUMMARY OF THE INVENTION

To address the above and other drawbacks of the prior art, there is disclosed a wire guide for interposition between an end of a cable, the cable comprised of at least two twisted pairs of conductors, and a plurality of connector terminals, at least two of the twisted pairs crossing between the cable end and the terminals. The wire guide comprises at least two guideways, wherein each of the twisted pairs is inserted into a respective one of the guideways, wherein the guideways guide each of the twisted pairs such that at a point of intersection the crossing twisted pairs are maintained substantially at right angles.

There is also disclosed a connector assembly for interconnecting an end of a cable comprising at least two twisted pairs of conductors, each of the conductors enveloped in an insulating covering, with the bifurcated contacts of a connecting block. The assembly comprises an insulated housing, at least two pairs of non-contacting conductive terminals disposed in the housing, each of the terminals comprising a blade exposed along a front face of the housing and adapted to be inserted into one of the bifurcated contacts, and a piercing mechanism, and at least two guideways between the cable end and the pair of conductive terminals, one guideway for guiding each of the twisted pairs, wherein two of the guideways are arranged such that, at a point of intersection, the twisted pairs carried by each of cross substantially at right angles. Each of the conductors is terminated by one of the terminals, the piercing mechanism puncturing the insulated covering of a free end of the conductor thereby bringing the terminal into conductive contact with the conductor.

Additionally, there is disclosed a method for adapting an end of a cable comprised of a plurality of twisted pairs of conductors, each of the conductors enveloped in an insulating covering and having a free end, for interconnection with the bifurcated conductors of a connecting block. The method comprises providing a connector assembly comprising a plurality non-contacting conductive terminals disposed in an insulated housing, each of the terminals comprising a blade exposed along a front face of the housing and adapted for insertion into the bifurcated conductors, and a piercing mechanism, inserting the free end of each of the conductors into the housing, crossing at least two of twisted pairs at a point of intersection substantially at right angles and for each terminal/conductor pair, puncturing the insulating covering the free end of each of the conductor with the piercing mechanism thereby bringing the terminal into conductive contact with the conductor.

### BRIEF DESCRIPTION OF THE DRAWINGS

FIG. 1 is a raised front perspective view of a connector assembly in accordance with an illustrative embodiment of the present invention;

FIG. 2 is an exploded raised rear perspective view of a connector assembly with the cover removed in accordance with an illustrative embodiment of the present invention;

FIG. 3 is an assembled view of the connector of FIG. 2;

FIG. 4 is an exploded raised rear perspective view of a terminal housing in accordance with an illustrative embodiment of the present invention;

FIG. 5 is a raised rear perspective view of a terminal in accordance with an illustrative embodiment of the present invention;

FIG. 6 is a raised rear perspective view of a wire guide in accordance with an illustrative embodiment of the present invention;

FIG. 7 is a raised rear perspective view of an assembled connector assembly with the insulating cover installed in accordance with an illustrative embodiment of the present invention;

FIG. 8 is a raised rear perspective view of an assembled connector assembly with the outer insulating protective housing installed in accordance with an illustrative embodiment of the present invention;

FIG. 9A is a front view of a connector assembly in accordance with an illustrative embodiment of the present invention;

FIG. 9B is a side cut-away view along 9B of the connector assembly in FIG. 9A;

FIG. 10 is a raised side perspective view of a connector assembly in accordance with an alternative illustrative embodiment of the present invention;

FIG. 11 is a raised front perspective view of a BIX connecting block; and

FIG. 12 is an adaptor in accordance with an alternative illustrative embodiment of the present invention.

### DETAILED DESCRIPTION OF THE ILLUSTRATIVE EMBODIMENTS

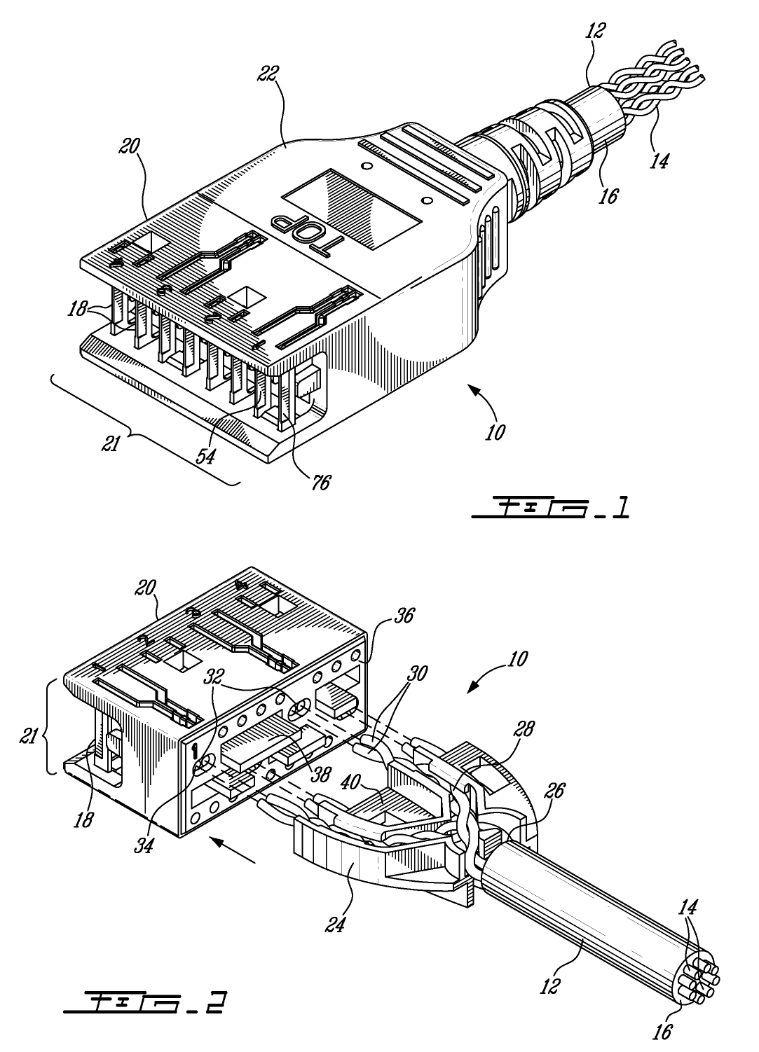

Referring to FIG. 1, a connector assembly, generally referred to using the numeral 10, is disclosed. The connector assembly 10 terminates a cable 12 comprised of a series of twisted pairs of conductors 14 covered in an insulating jacket 16 by a series of conductive terminals as in 18 fabricated, for example, from a single piece of rigid conducting material such as stamped phosphor bronze plated with nickel or gold. Each conductor 14 is manufactured, for example, from a conductive material such as of 23 or 24 gauge solid copper wire covered with a suitable dielectric insulating cover, although other gauges and types of conductors, such as stranded conductors, could be used.

The terminals 18 are retained within an insulated housing 20 and exposed along a front face 21 thereof, the housing fabricated, for example, from a non-conductive material such as injection moulded plastic. In the disclosed illustrative embodiment, the multi-conductor cable 12 comprises four (4) twisted pairs of conductors 14 terminated by eight (8) terminals 18, although it will be understood that other configurations would be possible, including those with one, two or three twisted pairs. The housing also illustratively includes an insulted protective covering 22 providing a gripping surface for removing and installing the assembly 10 from/to a connector block (not shown).

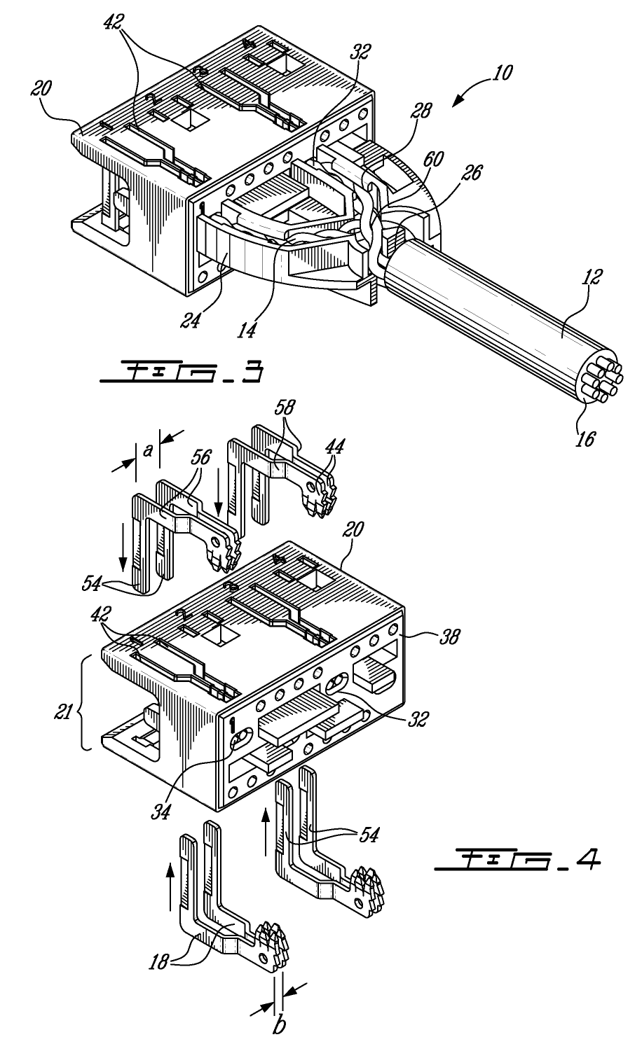

Referring now to FIG. 2, in order to align the twisted pairs of conductors 14 with the correct terminals 18, a wire guide 24 is disposed between the end 26 of the cable jacket 16 and the insulated housing 20. Guideways as in 28, illustratively in the form of channels, in the wire guide 24 separate and guide the twisted pairs of conductors 14 and align the free ends as in 30 of the conductors 14 with a series of pairs as in 32 of conductor accepting apertures 34 moulded in the rearward face 36 of the insulated housing 20.

During assembly, the free end 30 of each conductor 14 is inserted into its respective conductor accepting aperture as in 34 as the wire guide 24 is mounted onto the rearward face rearward face 36 of the insulated housing 20. The spacing between the aperture pair 32 terminating a given twisted pair of conductors 14 is adapted to be substantially the same as the separation between the conductors 14 of the twisted pair in their untwisted state. Additionally, a series of raised bosses 38 mate with corresponding cutaway portions 40 in the wire guide 24 thereby holding it securely to the insulated housing 20.

Referring to FIG. 3, an insulated housing 20 with a wire guide 24 mounted thereto is shown.

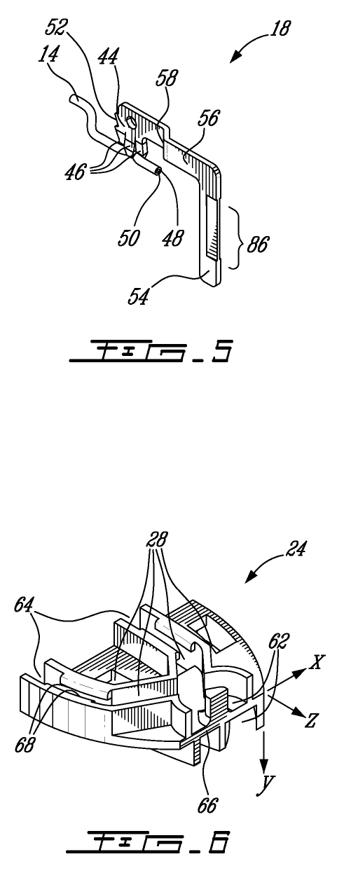

Referring now to FIG. 4 in addition to FIG. 3, once the conductors 14 have been inserted into the insulated housing 20 via the conductor accepting apertures 34, the terminals as in 18 are inserted into the insulated housing 20 via corresponding slots as in 42 moulded into the insulated housing 20, typically using a suitable tool (not shown).

Referring now to FIG. 5 in addition to FIG. 4, each terminal 18 is comprised at one end of a piercing mechanism 44 (illustratively a tri-point mechanism) comprised of a number of sharp teeth 46. As the terminal 18 is forced into the slot 42, typically by means of a suitable installation tool (not shown), the teeth 46 pierce (or are punched-through) the conductor 14, which is held firmly by an inner surface of the aperture 34, perforating the outer insulating cover 48 from the conductor 14 thereby providing electrical contact between the conductive core 50 and the terminal 18. Provision of this means of assembly means that the connector is suitable for assembly by both automated manufacturing means as well as by a technician in the field. Additionally, the use of the piercing, or punch-through, mechanism 44 for interconnecting each terminal 18 with a conductor 14 ensures that the distance between the individual conductors 14 of the twisted pairs can be rigorously maintained, thereby improving signal quality. Furthermore, the piercing mechanism 44 also ensures that the interconnecting surfaces between conductor 14 and terminal 18 are minimised, thereby reducing the deteriorating effect capacitance may have on any transmitted signals. Also included on each conductive terminal 18 is a securing mechanism 52, illustratively in the form of a serration, which on insertion of the terminal 18 into one of the slots as in 42, grips the housing 20 thereby retaining the terminal 18 within the slot 42.

Still referring to FIG. 5, the piercing mechanism 44 is connected to a terminal blade 54 by a conductive strip 56 which is attached towards one end of the blade 54. Illustratively, the conductive strip 56 is joined substantially at right angles to the blade 54. Referring back to FIG. 4 in addition to FIG. 5, in order to provide that the spacing “b” between the piercing mechanisms 44 of adjacent pairs of terminals 18 is less than the distance “a” between the blades 54 adjacent of adjacent pairs of terminals 18, a crimp as in 58 is, for example, formed in the conductive strips 56.

Still referring back to FIG. 4, the terminals 18 are illustratively arranged in pairs of terminals wherein the conductive strips 56 of adjacent pairs of terminals 18 are attached towards opposing ends of the terminal blades 54 (and as a result, when installed arranged towards opposite sides of the insulated housing 20). In this regard, it is foreseen that the pairs of terminals as in 18 are installed via slots as in 42 wherein the slots of adjacent pairs of terminals as in 18 are accessible through opposite first and second surfaces of the housing 20. Once the terminals have been inserted into their respective slots 42 in the housing 20, the piercing mechanisms 44 of the pairs of terminals 18 are aligned with the apertures 34 in the rear face 36 of the housing 20. In order that the piercing mechanisms 44 are correctly aligned with the apertures 34, the pairs of apertures as in 32 are staggered, with alternating aperture pairs 32 being closer to an opposite side of the housing 20. Arranging the terminals 18 and aperture pairs 32 in this manner permits the integrity of the performance of the cable/connector assembly to be maintained. Indeed, in order to transmit a high performance signal, the quality of the signal is maintained on each conductor of a given twisted pair due to its unique configuration. Different characteristics will determine the transmission performance according to the manner in which the twisted pairs are configured as well as the manner in which the twisted pairs interact with one another. The configuration of where and how the conductors are interconnected with the terminals, including the displacement between adjacent pairs of terminals, is an important aspect. In this regard, the staggering of the apertures 32 as described hereinabove, and therefore the point where the conductors 14 of different twisted pairs are interconnected with the terminals 18, serves to reduce the extent to which terminals 18 terminating a given twisted pair of conductors 14 interfere with other pairs of terminals 18, especially those terminal pairs which would otherwise be adjacent, and therefore in relative proximity.

Referring back to FIG. 3, the shape of the guideways 28 is illustratively selected such that the twisted pairs of conductors 14 terminate opposite their respective aperture pairs 32. Additionally, the guideways 28 guide the conductors 14 such that, for those twisted pairs which must necessarily cross in order to be aligned with their respective aperture pairs 32, the conductors 14 of these twisted pairs are held substantially at right angles at their points of intersection 60. Maintaining the crossing twisted pairs substantially at right angles reduces the interference between the crossing twisted pairs, thereby improving performance of the connector 10 as a whole. Also, as a connector cable 12 is typically terminated at both ends by the same type of connector assembly, the various components, including the wire guide 24, may be used as part of a connector assembly 10 at either end of the cable. Furthermore, a spacer (not shown), for example in the form of a sheath or shrink tube surrounding one of the crossing twisted pairs at least at the point of intersection 60 and illustratively fabricated from a shielding material, can be used to provide increased separation (i.e. a gap) between the crossing twisted pairs and therefore improve performance in terms of mutual interference.

Referring again to FIG. 4, by maintaining a short distance between the rearward face 36 of the insulated housing 20 and the piercing mechanisms 44, and thereby reducing the length of conductor 14 which must be unravelled from its twisted pair prior to insertion into the conductor accepting apertures 34, the signal performance can also be improved. Indeed, as is known to persons of ordinary skill in the art, the transmission of high quality high frequency signals depends to a large part on each conductor 14 of a twisted pair being maintained in a particular configuration. Additionally, the crimp 58 formed in the terminals 18 allows the distance “b” between the piercing mechanisms 44 of a pair of terminals 18, and therefore between the ends (reference 30 in FIG. 2) of the individual conductors 14 of each twisted pair to be optimised (for example, depending on the method of fabrication of the cable 12 which is terminated by the connector assembly 10) while maintaining the predetermined or standardised distance “a” between the blades as in 54 of each terminal 18. For example, in the disclosed illustrative BIX embodiment, a standardised distance is used for “a” between the blades 54 (which are illustratively arranged in parallel, evenly spaced along the front face 21 of the housing 20 and in a manner such that the blades 54 intersect the front face 21 at right angles) of 0.15 inches. On the other hand, the distance “b” between the piercing mechanisms 44 of a pair of terminals 18, and therefore the ends (reference 30 in FIG. 2) of the twisted pairs of conductors (reference 14 in FIG. 2), is 0.04 inches (although this could be varied depending on the type of twisted pair conductors 14 being terminated by the terminal 18).

Note that, in order to reduce the distance “b” such that it is similar or the same to the spacing between the conductors 14 of a given twisted pair, the use of interconnection mechanisms other than the piercing mechanisms 44, such as an IDC connection or a soldered interconnection, typically prove unsuitable. Indeed, both IDC connectors and solder would typically require a much larger displacement “b” between the terminals of a given pair in order to ensure that the terminals are not touching. Additionally, both IDC connections and soldered connections would typically require a terminal 18 having a much larger surface area at the point of interconnection as compared to the disclosed piercing mechanism 44, which, as discussed above, due to the increased capacitive effects would also have a negative effect on overall performance of the assembled connector 10.

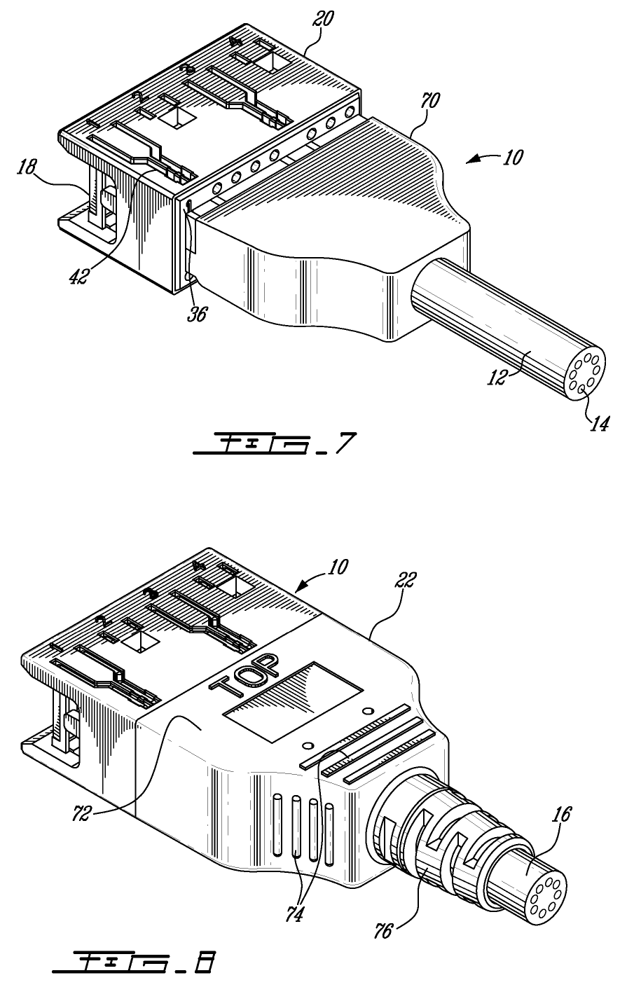

Referring now to FIG. 6, a detailed view of a wire guide 24 having four guideways 28 for guiding four twisted pairs of conductors (not shown) is disclosed. Referring to FIG. 3 in addition to FIG. 6. The wire guide 24 ensures that an appropriate separation is maintained between the twisted pairs of conductors 14 between the point where the twisted pairs exit the end 26 of the cable jacket 16 (the guideway inlet as in 62) and where each conductor 14 comes into contact with its respective terminal 18 (the guideway outlet as in 64). In particular, by selecting an appropriate thickness to the substantially flat diving layer 66 dividing the upper and lower guideways as in 28 (the “Y” direction) as well as the relative positions of the inlets 62 into the wire guide 24 (the “X” direction) inductive interaction between the twisted pairs can be minimised thus providing for an improved performance. Additionally, by varying length of the wire guide (the “Z” direction) the distance between where the twisted pairs of conductors 14 exit the end 26 of the cable jacket 16 and the point at which each conductor 14 is attached to a terminal 18 can also be optimised. Furthermore, within each guideway 28 a pair of protrusions 68 are provided for retaining the twisted pair of conductors 14 within the guideway 28 during assembly.

Still referring to FIG. 6, the wire guide can illustratively be fabricated from a dielectric such as plastic or a shielding material.

Referring now to FIG. 3 and FIG. 7, once the wire guide 24 is assembled to the rearward face 36 of the insulated housing 20, the individual conductors 14 of the cable 12 fed through their respective apertures (reference 32 on FIG. 2) and the terminals 18 inserted into their respective slots 42, an insulating material 70 is illustratively moulded over the wire guide 24/conductor 14 assembly. The insulating filler material 70 improves the robustness of the resulting assembly and is fabricated for example from a non-conducting material such as plastic. The use of injection moulding, for example, ensures penetration of the cover material into the guideways (channels) 28 filling them completely and thereby binding the conductors 14 within the guideways 28 of the wire guide 24. This in turn ensures that the positions of the twisted pairs of conductors 14 within the wire guide 24 will be strictly maintained, thereby improving the electrical transmission performance of the connector assembly 10 as well as the resulting mechanical strength of the connector assembly 10.

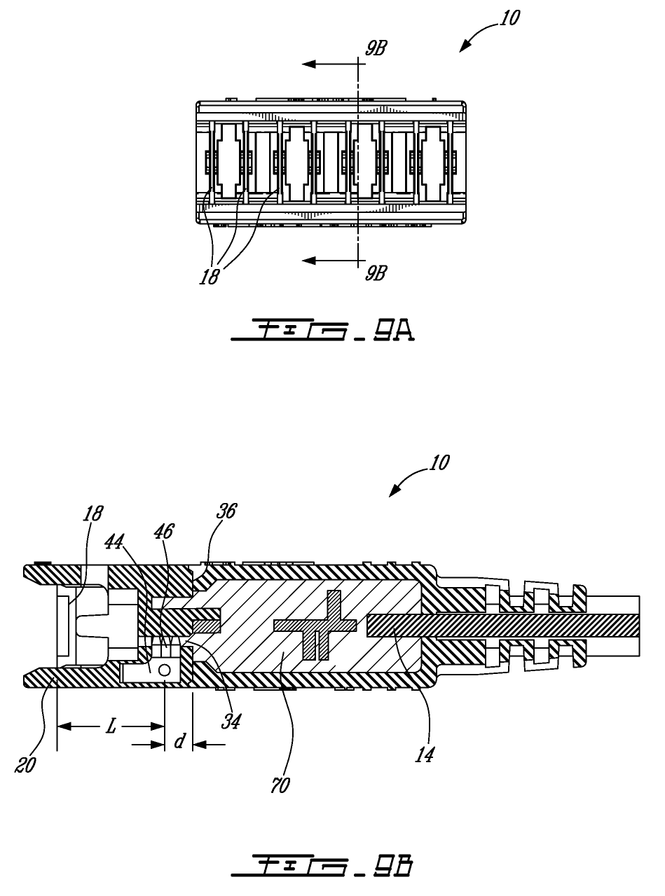

Referring now to FIG. 8, once wire guide 24 has been covered with the insulating filler material (reference 70 in FIG. 7), the insulating protective cover 22 is then moulded over the insulating material 70. The insulating protective cover 22 is manufactured, for example, from a pliable non-conducting material such as a rubberised plastic or the like. In the surface 72 of the cover 22 a series of gripping ridges 74 are formed to provide an improved grip when the connector assembly 10 is being inserted into or withdrawn from a connector block. The colour of the material used to form the outer insulating protective cover 22 may also be varied for a given application. Additionally, and in order to improve the mechanical robustness of the connector/cable interconnection, a reinforcing collar 76 is also moulded between the protective cover 22 and the cable jacket 16.

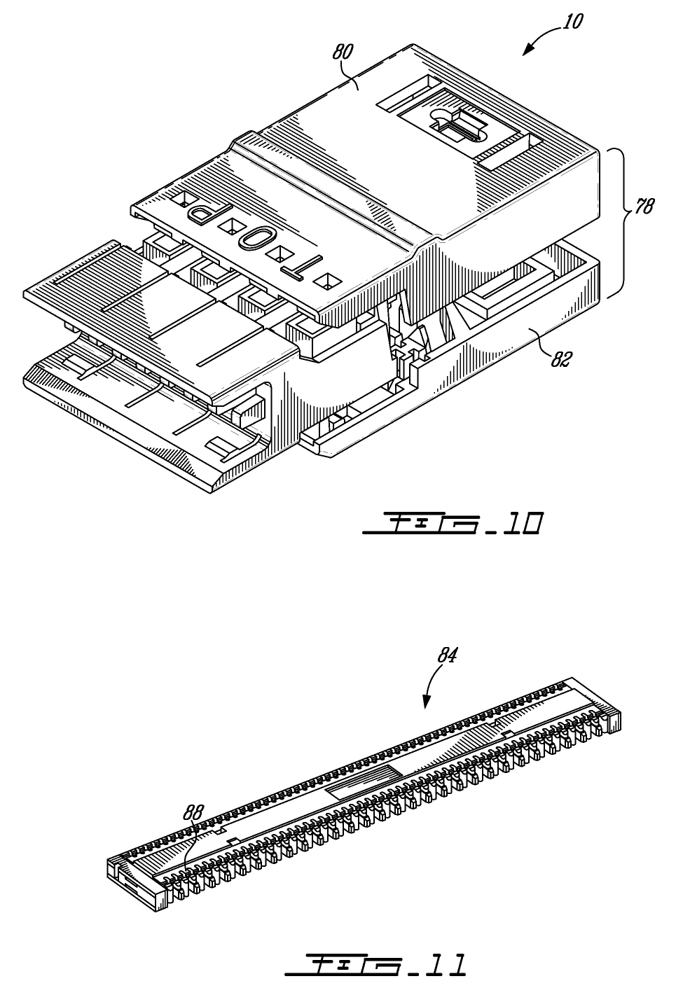

Referring now to FIGS. 9a and 9b, the assembled connector assembly 10 minimises the distance “d” between the rearward face 36 of the insulated housing 20 and the point at which contact is made between the terminal 18 and the conductor 14 via the teeth 46 of the piercing mechanism 44. Additionally, using the injection moulding technique the twisted pairs of conductors 14 are encased in the plastic of the insulating material 70.

Provided requisite care is taken during the fabrication of the connector assembly, the connector assembly 10 as described is sufficient to meet the performance requirements of Category 6 pursuant to TIA/EIA T-568-B.2-1.

Referring to FIG. 10, alternatively the insulating material 70 and outer insulating protective cover 22 of FIG. 7 could be replaced by a suitable cover assembly 78 comprised of a first part 80 and a second part 82 which snap fit together to hold the wire guide and twisted pairs in place.

Referring now to FIGS. 1, 5 and 11, one or more connector assemblies 10 are designed to mate with a connecting block 84 by inserting the contact regions (reference 86 on FIG. 5) of the terminal blades (reference 54 on FIG. 5) between a series of bifurcated contact slots 88, for example fabricated from a rigid conducting material such as stamped phosphor bronze plated with nickel or gold. Illustratively, the contact regions (or forward edges) 86 of the blades 54 are chamfered in order to facilitate their insertion between the bifurcated contact slots 88. As will be understood by persons of ordinary skill in the art, multiple connector assemblies 10 can be arranged side by side on a given connecting block 84. Although the connecting block disclosed is that known having the designation BIX, it will be understood by persons of ordinary skill in the art that a variety of other connecting blocks may also be used, for example those known in the art as 110 cross connector blocks or KRONE.

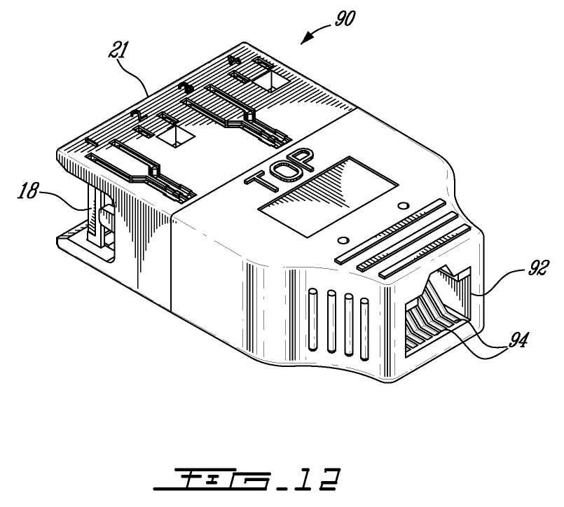

Still referring to FIGS. 1 and 11, in an alternative embodiment the connector assembly 10 and cable 12 of the present invention could assembled with a second connector assembly 10 mounted on a second end of the cable 12 resulting in a patchcord (not shown) suitable, for example, for interconnecting two connector blocks as in 84, or different series of bifurcated contact slots as in 88 on the same connector block 84. Additionally, a connector assembly as in 10 could be assembled to the first end of a cable 12 with a device mounted on the second end of the cable 12, for example an RJ-45 plug or the like, providing a patchcord allowing a connector block 84 to be interconnected with a standard RJ-45 socket or the like. Alternatively, a device such as an electronic testing apparatus could be attached directly to the second end of the cable 12. Also, the conductors 14 at the second end of the cable 12 could be exposed and inserted directly into the bifurcated contact slots 86 of a connector block 84.

In an alternative illustrative embodiment of the present invention, one or more of the terminal blades 54 are adapted to move perpendicularly relative to the front face 21 of the housing 20, with the moveable blades 54 being normally biased (for example using an insulated spring or the like) towards the front face 21. Such a configuration would be useful, for example, in a test setting where a connector 10 is repeatedly connected to and then removed from a contact slot as in 88. Although both the terminal blades 18 and the bifurcated contact slots 88 are both designed to endure a number of insertions and removals, repeated insertion and removal will eventually cause either the terminal blades 18, the bifurcated contact slots 88 or both to fail. Providing for the moveable blades 54 allows, for example, the terminals 18 to make contact with the bifurcated contact slots 88 without being inserted between the bifurcated contact slots 88, thereby reducing the wear and tear.

Referring to FIG. 12, in a second alternative illustrative embodiment the connector assembly can be modified to provide an adaptor as in 90 suitable for interconnecting the connector block 84 of FIG. 11 with, for example, a cable terminated with an RJ-45 plug or the like. In this regard, the adaptor 90 comprises a socket 92 moulded in a first rear surface thereof having a plurality of conductive elements as in 94 mounted therein. Each of the conductive elements as in 94 are interconnected with a respective one of the terminals as in 18 exposed along a front face 21 of the adaptor 90. Insertion of cable terminated with an appropriate plug (both not shown) into the socket 92 brings the conductors of the cable (again, not shown) into contact with a respective one of the elements as in 94 and as a result, the terminals as in 18. A person of ordinary skill of the art will now appreciate that an adaptor 90 equipped with a suitable socket 92 can be used to terminate a cable equipped with a plug of a different type with, for example, the connector block 84 of FIG. 11. Although not shown, a person of ordinary skill in the art will also appreciate that, if twisted pairs of conductors are used to interconnect the elements 94 with the terminals 18, the wire guides, terminals, etc., as discussed hereinabove could also be used to advantage, thereby ensuring that the adaptor 90 meets Category 6 performance requirements.

Although the present invention has been described hereinabove by way of an illustrative embodiment thereof, this embodiment can be modified at will without departing from the spirit and nature of the subject invention.

What is claimed is:

1. A wire guide for interposition between an end of a cable, the cable comprised of at least two twisted pairs of conductors, and a plurality of connector terminals, at least two of the twisted pairs crossing between the cable end and the terminals, the wire guide comprising:
at least two guideways, wherein each of the twisted pairs is inserted into a respective one of said guideways;
wherein said guideways guide each of the twisted pairs such that at a point of intersection the crossing twisted pairs are maintained substantially at right angles.

2. The wire guide of claim 1, wherein each of said guideways comprises an inlet and an outlet and wherein a spacing and positioning of said inlets is adapted to substantially maintain a spacing and positioning of the twisted pairs as they exit the cable end.

3. The wire guide of claim 1, wherein the cable comprises four twisted pairs, wherein said wire guide comprises four of said guideways and wherein said wire guide further comprises a substantially flat dividing layer, two of said guideways positioned on a first side of said dividing layer and two of said guideways positioned on a second side of said dividing layer.

4. The wire guide of claim 3, wherein said guideways on said first side of said dividing layer are intersecting guideways.

5. The wire guide of claim 4, wherein said guideways on said second side of said dividing layer are non-intersecting guideways.

6. The wire guide of claim 1, wherein each of said guideways comprises a channel.

7. The wire guide of claim 6, wherein each of said channels comprises a pair of opposed cable retaining protrusions moulded in opposing sidewalls thereof.

8. The wire guide of claim 1, wherein a spacer is inserted between the crossing twisted pairs at said point of intersection.

9. The wire guide claim 8, wherein said spacer comprises a sheath covering at least one of the crossing twisted pairs at said point of intersection.

10. The wire guide of claim 1, wherein the wire guide is fabricated from a shielding material.

11. The wire guide of claim 1, wherein the wire guide is fabricated from a non-conductive material.

12. A connector assembly for interconnecting an end of a cable comprising at least two twisted pairs of conductors, each of the conductors enveloped in an insulating covering, with the bifurcated contacts of a connecting block, the assembly comprising:
an insulated housing;
at least two pairs of non-contacting conductive terminals disposed in said housing, each of said terminals comprising a blade exposed along a front face of said housing and adapted to be inserted into one of the bifurcated contacts, and a piercing mechanism; and
at least two guideways between the cable end and said pair of conductive terminals, one guideway for guiding each of the twisted pairs, wherein two of said guideways are arranged such that, at a point of intersection, the twisted pairs carried by each of cross substantially at right angles;
wherein each of the conductors is terminated by one of said terminals, said piercing mechanism puncturing the insulated covering of a free end of the conductor thereby bringing said terminal into conductive contact with the conductor.

13. The connector assembly of claim 12, wherein said guideways are channels.

14. The connector assembly of claim 13, wherein the twisted pairs are retained in said channels by a filler material.

15. The connector assembly of claim 14, wherein said filler material is plastic.

16. The connector assembly of claim 12, wherein said guideways each comprise an inlet and an outlet and wherein a spacing and positioning of said inlets relative to one another is adapted to substantially maintain a spacing and positioning of the twisted pairs as they exit the end of the cable.

17. A method for adapting an end of a cable comprised of a plurality of twisted pairs of conductors, each of the conductors enveloped in an insulating covering and having a free end, for interconnection with the bifurcated conductors of a connecting block, the method comprising:
providing a connector assembly comprising a plurality non-contacting conductive terminals disposed in an insulated housing, each of said terminals comprising a blade exposed along a front face of said housing and adapted for insertion into the bifurcated conductors, and a piercing mechanism;
inserting the free end of each of the conductors into said housing;
crossing at least two of twisted pairs at a point of intersection substantially at right angles and
for each terminal/conductor pair, puncturing the insulating covering the free end of each of the conductor with said piercing mechanism thereby bringing said terminal into conductive contact with the conductor.

18. The method of claim 17, wherein each of said piercing mechanisms is a tri-point mechanism.

19. The method of claim 17, further comprising maintaining a gap between the crossing twisted pairs at said point of intersection.

20. The method of claim 19, wherein said gap maintaining act comprises covering at least one of the crossing twisted pairs at least at said point of intersection in a sheath.

21. The method of claim 17, wherein each of said guideways comprises a channel and further comprising the act following said inserting act of filling said channels with a channel filler material.
